(19) United States
(12) Patent Application Publication
(10) Pub. No.: US 2009/0240500 A1
(43) Pub. Date: Sep. 24, 2009

(54) SPEECH RECOGNITION APPARATUS AND METHOD

(75) Inventors: Mitsuyoshi TACHIMORI, Kawasaki-shi (JP); Shinichi TANAKA, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/407,145

(22) Filed: Mar. 19, 2009

(30) Foreign Application Priority Data
Mar. 19, 2008 (JP) 2008-071568

(51) Int. Cl. G10L 15/18

(52) U.S. Cl. 704/257; 704/E15.005

(57) ABSTRACT

A speech recognition apparatus includes a storage unit which store vocabularies, each of vocabularies including plural word body data, each of the word body data obtained by removing a specific word head from a word or sentence, and store at least one word head portion including labeled nodes to express at least one common word head common to at least two of the vocabularies, an instruction receiving unit which receive an instruction of a target vocabulary and an instruction of a operation, a grammar network generating unit which generate, when adding is instructed, a grammar network containing the word head portion, the target vocabulary and connection information indicating that each of the word body data contained in the target vocabulary is connected to a specific one of the labeled nodes contained in the word head portion, and a speech recognition unit which execute speech recognition using the generated grammar network.

### CROSS-REFERENCE TO RELATED APPLICATIONS

This application is based upon and claims the benefit of priority from prior Japanese Patent Application No. 2008-071568, filed Mar. 19, 2008, the entire contents of which are incorporated herein by reference.

### BACKGROUND OF THE INVENTION

1. Field of the Invention

The present invention relates to a speech recognition apparatus and a speech recognition method.

2. Description of the Related Art

As a technology regarding the speech recognition apparatus, an art for generating a grammar for speech recognition is available. The grammar (or speech recognition grammar) mentioned here means data or information by which one or more speech recognition target vocabularies are provided. The vocabulary mentioned here means a set of words or sentences. The speech recognition apparatus regards each of one or more vocabularies provided by the grammar at the time of executing the speech recognition as speech recognition target vocabulary.

As one of the grammar generation arts, there is available a method of generating the grammar by combining vocabularies corresponding to a situation (for example, corresponding to the status or the mode of an apparatus). As a specific example, an example of the generation method of speech recognition grammar in a car navigation system will be described. In the car navigation system, the grammar is constituted of just a vocabulary for car navigation operation commands under a mode just after the power is turned on (that is, initial condition). When a command is entered by user in the initial condition, other mode (for example, map retrieval mode or telephone number retrieval mode) is selected. When that selected mode is reached, one or more vocabularies corresponding to operation category inherent of that other mode are added to the grammar in the initial condition. After that, depending on from which mode to which mode a transition is made, one or more necessary vocabularies are added to the grammar before that the transition and/or one or more unnecessary vocabularies are deleted therefrom.

In the above-described example, the speech recognition grammar is just a set of vocabularies. Here, assume that the grammar is X and vocabularies prepared preliminarily are X₁ to Xₙ. When k vocabularies {Xᵢ₁, Xᵢ₂, . . . Xᵢₖ} are selected from X₁ to Xₙ, a grammar X=Xᵢ₁+Xᵢ₂+ . . . +Xᵢₖ. If m vocabularies {X_{d1}, X_{d2}, . . . X_{dm}} to be deleted are selected from the k vocabularies {Xᵢ₁, Xᵢ₂, . . . Xᵢₖ}, the grammar can be updated by an deletion operation of X←X−X_{d1}−X_{d2}− . . . X_{dm}.

As a more general case, consider a grammar in which the sentence pattern is determined preliminarily and one or more words in the sentence are variable. Here, a Japanese sentence pattern of “X no Y (Y of X)” will be explained as an example. In the example of the sentence pattern of this “X no Y”, any arbitrary vocabulary for X can be set in X and arbitrary vocabulary for Y can be set in Y. For example, if X and Y are set to {KANREN-GAISHA (affiliate company), KO-GAISHA (subsidiary company)} and {JUSHO (address), DENWABANGO (telephone number)} respectively, a grammar for expressing four sentences “KANREN-GAISHA no JUSHO (address of affiliate company)”, “DENWABANGO no KANREN-GAISHA (telephone number of affiliate company)”, “KOGAISHA no JUSHO (address of subsidiary company)”, “KOGAISHA no DENWABGANGO (telephone number of subsidiary company)” is obtained. In this example also, like the example of the aforementioned car navigation system, generation and updating of the grammar are enabled by selecting some vocabularies from vocabularies prepared preliminarily and operating to combine the selected vocabularies (operating to add) like, for example, X=Xᵢ₁+Xᵢ₂+ . . . +Xᵢₘ, Y=Yᵢ₁+Yᵢ₂+ . . . +Yᵢₙ and/or operating to delete the vocabularies.

As a method for expressing the vocabulary for use in speech recognition, a method for expressing the vocabulary with a network is available (see, for example, Stephen E. Levinson: “Structural Methods in Automatic Speech Recognition”, Proceedings of the IEEE. Vol. 73, No. 11, pp. 1625-1650. November 1985). When the vocabulary network is used also, the addition/deletion of the vocabularies can occur.

As a conventional method for executing addition/deletion of the vocabulary network, a method which considers a merging of the word head common to plural words (common word head) and a merging of the word tail common to plural words (common word tail) is available. By merging the common word head/common word tail, the memory amount and calculation amount can be reduced. However, this method has such a problem that it takes relatively much calculation time for processing which considers the merging.

On the other hand, as another method for executing the addition/deletion of the vocabulary network, there is a method of connecting plural vocabulary networks just in parallel to each other. This method has another problem that although the processing is simple, it needs more memory amount and calculation amount than a case of considering the merging of the common word head/common word tail.

As described above, conventionally, there is no method which executes the addition/deletion of the vocabulary efficiently.

### BRIEF SUMMARY OF THE INVENTION

According to an aspect of the present invention, there is provided a speech recognition apparatus using a grammar network which provides a set of recognition target words or sentences, which includes a storage unit configured to store a plurality of vocabularies, each of the vocabularies including a plurality of word body data, each of the word body data being obtained by removing a specific word head from an arbitrary word or sentence, and store at least one word head portion including a plurality of labeled nodes in order to express at least one common word head common to at least two of said plurality of vocabularies; an instruction receiving unit configured to receive a first instruction for selecting a target vocabulary from said plurality of vocabularies and a second instruction for instructing the content of a operation to the target vocabulary; a grammar network generating unit configured to generate, when a processing for adding the target vocabulary is instructed by the first instruction, a grammar network containing the word head portion, the target vocabulary selected by the second instruction and word head portion side connection information indicating that each of said plurality of the word body data contained in the target vocabulary is connected to a preliminarily matched one of said plurality of labeled nodes contained in the word head portion; and a speech recognition unit configured to execute speech recognition using the generated grammar network.

### BRIEF DESCRIPTION OF THE SEVERAL VIEWS OF THE DRAWING

FIG. 1 is a diagram showing an example of the configuration of the speech recognition apparatus according to an embodiment;

FIG. 2 is a diagram showing an example of the internal configuration of a grammar editing unit;

FIG. 3 is a flow chart showing an example of a processing procedure from vocabulary operation to registration;

FIG. 4 is a diagram showing an example of a grammar frame;

FIG. 5 is a diagram showing a word head portion and a word tail portion;

FIG. 6 is a diagram showing a first example of a vocabulary network (word body portion);

FIG. 7 is a diagram showing a second example of a vocabulary network (word body portion);

FIG. 8 is a diagram showing a third example of a vocabulary network (word body portion);

FIG. 9 is a flow chart showing an example of processing procedure of grammar network generation;

FIG. 10 shows an example of the processing procedure of addition routine in FIG. 9;

FIG. 11 shows an example of the processing procedure of deletion routine in FIG. 9;

FIG. 12 shows a network structure of the grammar frame processed by initial setting procedure;

FIG. 13 is a diagram showing an example of the network structure of a grammar frame to which the addition routine is executed;

FIG. 14 is a diagram showing another example of the grammar frame;

FIG. 15 is a diagram showing an example of the structure of a word body portion which can be used for two sub-networks;

FIG. 16 is a flow chart showing another example of the processing procedure of grammar network generation;

FIG. 17 is a flow chart showing an example of the processing procedure of addition routine in FIG. 16;

FIG. 18 is a flow chart showing an example of the processing procedure of deletion routine in FIG. 16;

FIG. 19 is a diagram showing another example of the word head portion;

FIG. 20 is a diagram showing a fourth example of a vocabulary network (word body portion);

FIG. 21 is a diagram showing a fifth example of a vocabulary network (word body portion);

FIG. 22 is a diagram showing a sixth example of a vocabulary network (word body portion);

FIG. 23 is a diagram showing another example of the internal configuration of the grammar editing unit;

FIG. 24 is a flow chart showing an example of the processing procedure for updating the word head portion;

FIG. 25 is a flow chart showing an example of the processing procedure of merge routine in FIG. 24;

FIG. 26 is a flow chart showing an example of the processing procedure of merge execute routine in FIG. 25;

FIG. 27 is a first diagram for explaining the addition operation/deletion operation of a conventional vocabulary network;

FIG. 28 is a second diagram for explaining the addition operation/deletion operation of the conventional vocabulary network;

FIG. 29 is a third diagram for explaining the addition operation/deletion operation of the conventional vocabulary network;

FIG. 30 is a fourth diagram for explaining the addition operation/deletion operation of the conventional vocabulary network; and

FIG. 31 is a fifth diagram for explaining the addition operation/deletion operation of the conventional vocabulary network.

### DETAILED DESCRIPTION OF THE INVENTION

Hereinafter, the embodiments of the present invention will be described with reference to the accompanying drawings.

### First Embodiment

First, a method for expressing the vocabulary with a network will be described and further, problems of conventional arts will be described in detail based on this expression method.

Generally, expressing the vocabulary for use in speech recognition with the network has following two advantages.

(i) Different words having a common word head can share data (node and arc of network) of the common word head and/or different words having a common word tail can share data of the common word tail. Consequently, vocabularies can be held with a smaller memory amount.

(ii) By sharing the common word head and/or the common word tail, a word score calculation necessary for speech recognition can be shared. Consequently, a word score can be calculated with a smaller calculation amount.

In the meantime, according to a method of expressing the vocabulary with a tree structure, the word head is shared while the word tail is not shared. Thus, the tree structure is a kind of the network.

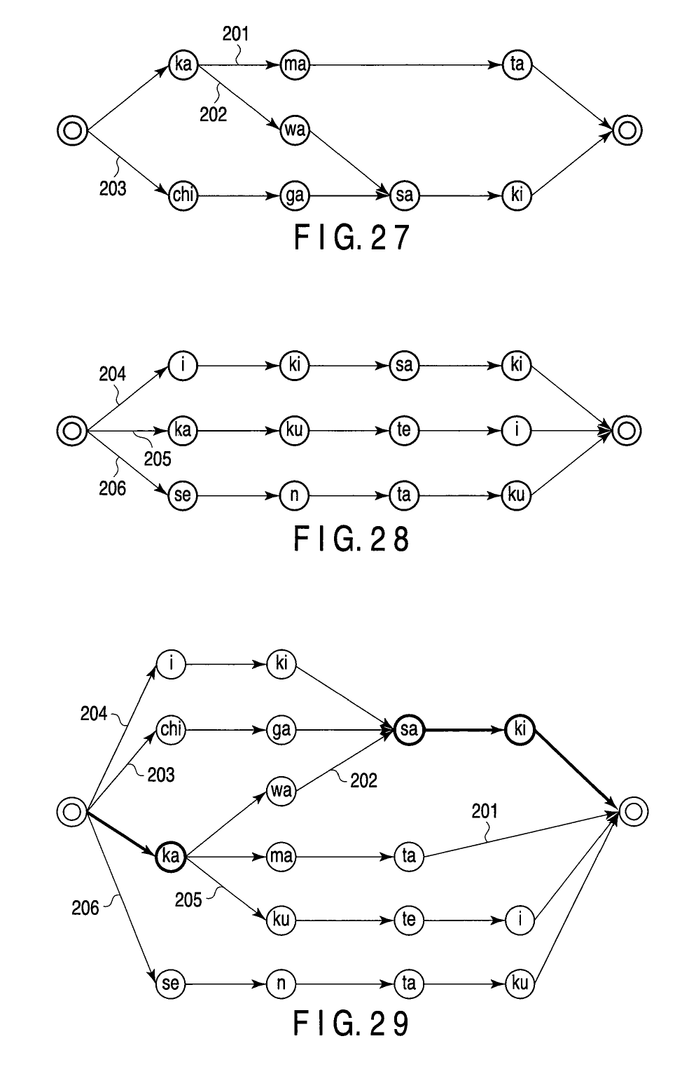

FIG. 27 shows an example of the vocabulary network in which plural words are expressed. FIG. 27 expresses three Japanese words (names of city), “ka-ma-ta” (route 201 in the Figure), “ka-wa-sa-ki” (route 202 in the Figure), “chi-ga-sa-ki” (route 203 in the Figure). In FIG. 27, the common word head “ka” is shared and the common word tail “sa-ki” is shared.

FIG. 28 shows other example of the vocabulary network. FIG. 28 expresses three Japanese words, “i-ki-sa-ki (destination)” (route 204 in the Figure), “ka-ku-te-i (determination)” (route 205 in the Figure) and “se-n-ta-ku (selection)” (route 206 in the Figure). In FIG. 28, no word head and word tail are shared.

When expressing the vocabulary with a network, a conventional method for implementation addition of vocabularies (combination of vocabularies) is to add a new vocabulary network to an existing vocabulary network and then to merge the common word head and/or the common word tail.

For example, if the vocabulary network of FIG. 28 is merged with the vocabulary network of FIG. 27, a vocabulary network shown in FIG. 29 is obtained. This vocabulary network provides a grammar (grammar network) for speech recognition. The routes with the same reference numerals in FIGS. 27 to 29 indicate the same word.

deleting of the vocabulary is carried out in a reverse way to the above-described one, for example, by deleting the vocabulary network of FIG. 28 from the vocabulary network of FIG. 29, the vocabulary network of FIG. 27 is obtained.

However, it takes relatively much calculation time to add the vocabulary network and merge the common word head and/or the common word tail as described above, which is a problem. Once merger is executed, an unnecessary vocabulary need to be deleted with the merged network structure maintained, thereby requiring a calculation time. Thus, such an addition and deletion method of the vocabulary network is not suitable for a case where the number of words is large or the processing capacity of a computer is low.

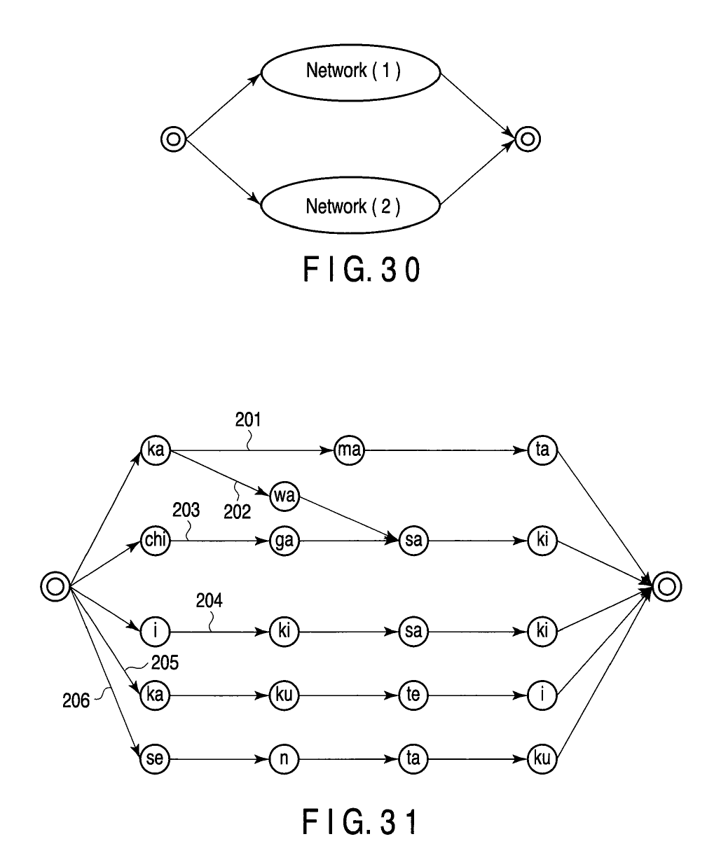

On the other hand, when the vocabulary is expressed with the network, another conventional method for achieving addition of the vocabulary is to prepare plural vocabulary networks preliminarily and connect two or more vocabulary networks selected from those just in parallel. FIG. 30 shows a case where two vocabulary networks are selected.

For example, if the vocabulary network of FIG. 27 and the vocabulary network of FIG. 28 are selected, a vocabulary network (or grammar network) shown in FIG. 31 is obtained.

According to the above-described method, the addition/deletion of the vocabulary network is carried out by only adding/deleting an operating target vocabulary network to/from the network. Consequently, high-speed operation is enabled (the above-described method has been actually used).

However, according to this method, sharing of the common word head/common word tail can be done only within each of vocabulary networks prepared preliminarily. Thus, if the number of the networks is increased or the processing capacity of the computer is low, waste of memory for a not-merged portion or waste of a time taken for word score calculation cannot be neglected, which is another problem.

The above-described problem exists in a grammar having a sentence pattern like “Y of X” as well as a grammar which is just a sum of sets of words when attention is paid to X or Y and the same thing can be said of other grammar.

Hereinafter, this embodiment will be described in detail.

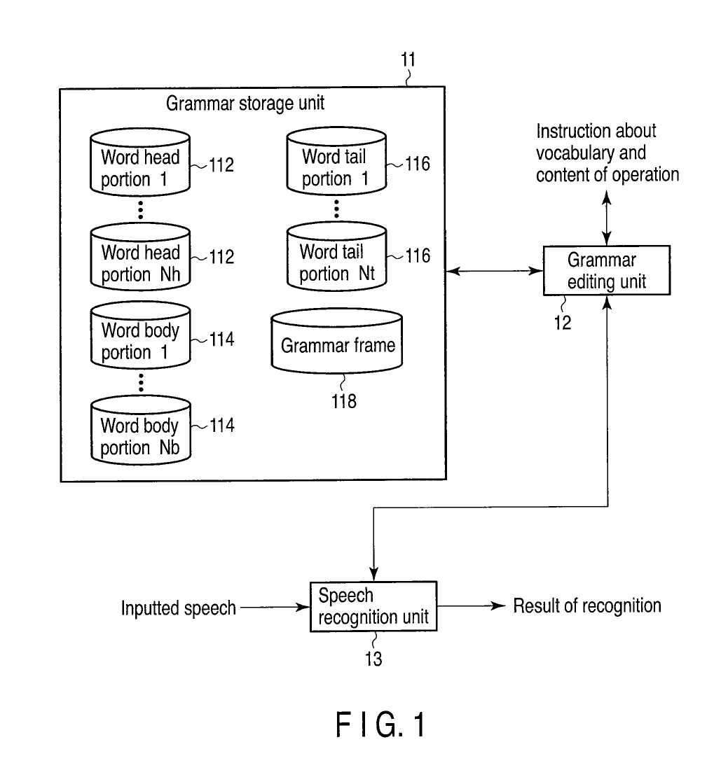

FIG. 1 is a block diagram showing an example of the configuration of a speech recognition apparatus of this embodiment.

As shown in FIG. 1, the speech recognition apparatus of this embodiment includes a grammar storage unit 11, a grammar editing unit 12 and a speech recognition unit 13.

The grammar storage unit 11 stores one or more word head portions (112 in the Figure), one or more word tail portions (114 in the Figure), two or more word body portions (116 in the Figure) and one or more grammar frames (118 in the Figure).

In this embodiment, a speech recognition target word or sentence is consisted of all or some of a word head, a word body and a word tail (Typically, it is consisted of all of them).

The word head of the word or sentence is a part in a certain range on the word head side of the word or sentence (word head side part) and the word tail of the word or sentence is a part in a certain range on the word tail side of the word or sentence (word tail side part). The word body of an individual word or sentence contained in the vocabulary is picked up by removing the word head and/or the word tail from that word or sentence.

The word head portion 112 includes one or more word head data (i.e., labeled node in this embodiment), and expresses one or more (common) word heads respectively common to at least two vocabularies, and, which will be described in detail later.

The word tail portion 116 includes one or more word tail data (i.e., labeled node in this embodiment), and expresses one or more (common) word tails respectively common to at least two vocabularies, and, which will be described in detail later.

A vocabulary expresses a plurality of words or sentences.

The word body portion (i.e., vocabulary network in this embodiment) 114 includes a plurality of word body data (i.e., word body network in this embodiment), and expresses a plurality of words or sentences. One word body data expresses one word or sentence corresponding to the word body data when the word body data is combined with a matching word head data of the word head portion and a matching word tail data of the word tail portion, which will be described in detail later.

A quantity Nₕ of the word head portion 112 and a quantity N_{b} of the word tail portion 116 are smaller than a quantity Nₜ of the word body portion 114. That is, 1≦Nₕ<N_{b} and 1≦Nₜ<N_{b}.

The grammar frame 118 is a network which defines a connecting method (sentence pattern) between the vocabularies, which will be described in detail later.

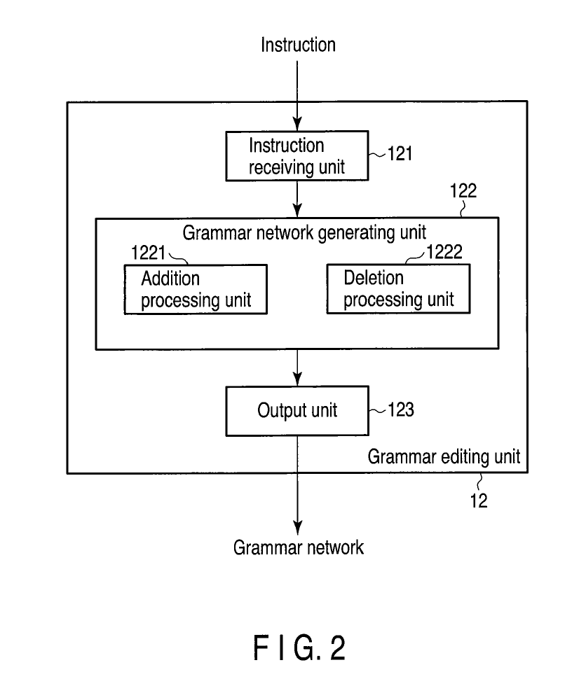

As shown in FIG. 2, the grammar editing unit 12 includes an instruction receiving unit 121, an grammar network generating unit 122 and an output unit 123. The grammar network generating unit 122 contains an addition processing unit 1221 and an deletion processing unit 1222.

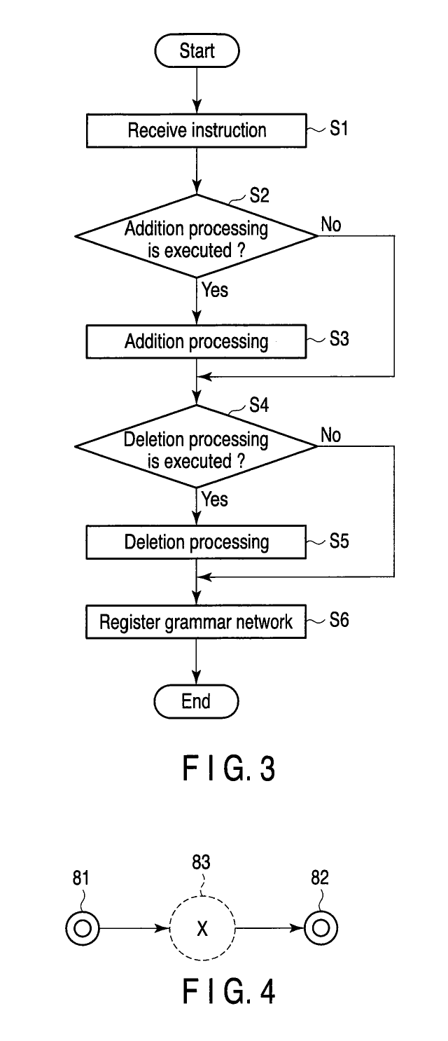

There will now be described an example of the processing procedure from vocabulary operation to the grammar network to registration of the grammar network by the grammar editing unit 12 and the speech recognition unit 13 of the speech recognition apparatus referring to FIG. 3.

The instruction receiving unit 121 receives a vocabulary selection instruction for selecting a vocabulary to be an operating target and an operation selection instruction for selecting the content (that is, any one of addition and deletion) of an operation to that vocabulary (step S1). As a method by which user inputs a desired instruction and the instruction receiving unit 121 receives this instruction, it is permissible to use any method, for example, GUI.

If addition is instructed by the operation selection instruction (step S2), the addition processing unit 1221 of the grammar network generating unit 122 connects each of the word body data of the word body portion corresponding to the instructed vocabulary by the vocabulary selection instruction to a preliminarily specified word head data of the word head portion and a preliminarily specified word tail data of the word tail portion (step S3). On the other hand, if deletion is instructed (step S4), the deletion processing unit 1222 of the grammar network generating unit 122 disconnect each of the word body data from the word head data and the word tail data (step S5). By the addition and/or deletion of the vocabulary, a grammar network is generated or updated.

The output unit 123 outputs the generated or updated grammar network to the speech recognition unit 13 and registers the grammar network in the speech recognition unit 13.

Entry of an instruction to the instruction receiving unit 121 may be carried out for each vocabulary or collectively for plural vocabularies. In the latter case, addition of one or more vocabularies and deletion of one or more vocabularies may be carried out at the same time. Any one of addition of plural vocabularies and deletion of plural vocabularies may be executed at the same time.

When the speech recognition unit 13 receives a grammar network from the grammar editing unit 12, it registers this in a memory (not shown) as an initial or updated grammar network (step S6). The speech recognition unit 13 executes speech recognition to inputted voice using the updated grammar network registered currently and outputs a result of the speech recognition. The speech recognition unit 13 may be of the same structure as the conventional one.

Next, an example of the operation of the grammar editing unit 12 of the speech recognition apparatus of this embodiment will be described with reference to FIGS. 4 to 11. FIGS. 4 to 8 are conceptual diagrams of data to be stored in the grammar storage unit 11. FIGS. 9 to 11 are flow charts showing an example of the operation of the grammar editing unit 12.

The grammar frame is a model of the network indicating the sentence pattern which the speech recognition apparatus can receive. The grammar frame is constituted of at least one or more “part in which the vocabulary is variable”. The “part in which the vocabulary is variable” in the grammar frame is called “sub-network”. The grammar frame can contain one or more “part in which the vocabulary is fixed”. The “part in which the vocabulary is fixed” in the grammar frame is called “vocabulary fixing node”.

FIG. 4 shows an example of the simplest grammar frame. This grammar frame indicates that the vocabulary is set in X. A head node (81 in the Figure) represented by double circles in FIG. 4 indicates a node in the initial condition and a tail node (82 in the Figure) represented by double circles indicate a node in the final condition. To distinguish the sub-network from the node, the sub-network (83 in the Figure) is indicated with dotted lines and the node (81, 82 in the Figure) is indicated with a solid line (this is the same in other drawings). In case of FIG. 4, the grammar editing unit 12 generates the grammar network by adding/deleting the vocabulary to/from the sub-network X.

The grammar frame has various sentence patterns. For instance, FIG. 14 shows an example of the grammar frame indicating a sentence pattern of “X-no-Y” (no: particle indicating state of possession, belonging and character, etc). In the case of FIG. 14, the grammar editing unit 12 defines the grammar network by setting one or more vocabularies in each of sub-networks X, Y.

To clarify the feature of this embodiment, a case where one word head portion 112 (that is, Nₕ=1) and one word tail portion 116 (that is, Nₜ=1) are provided and the grammar frame holds a sub-network X will be exemplified. Further, a case where the node label is Japanese KANA letter will be described. In this case, the KANA letters are expressed in Roman letters. Although a case where the vocabulary provides a set of the words will be described as an example, a case where the vocabulary provides a set of the sentences or a set of the words and sentences is the same.

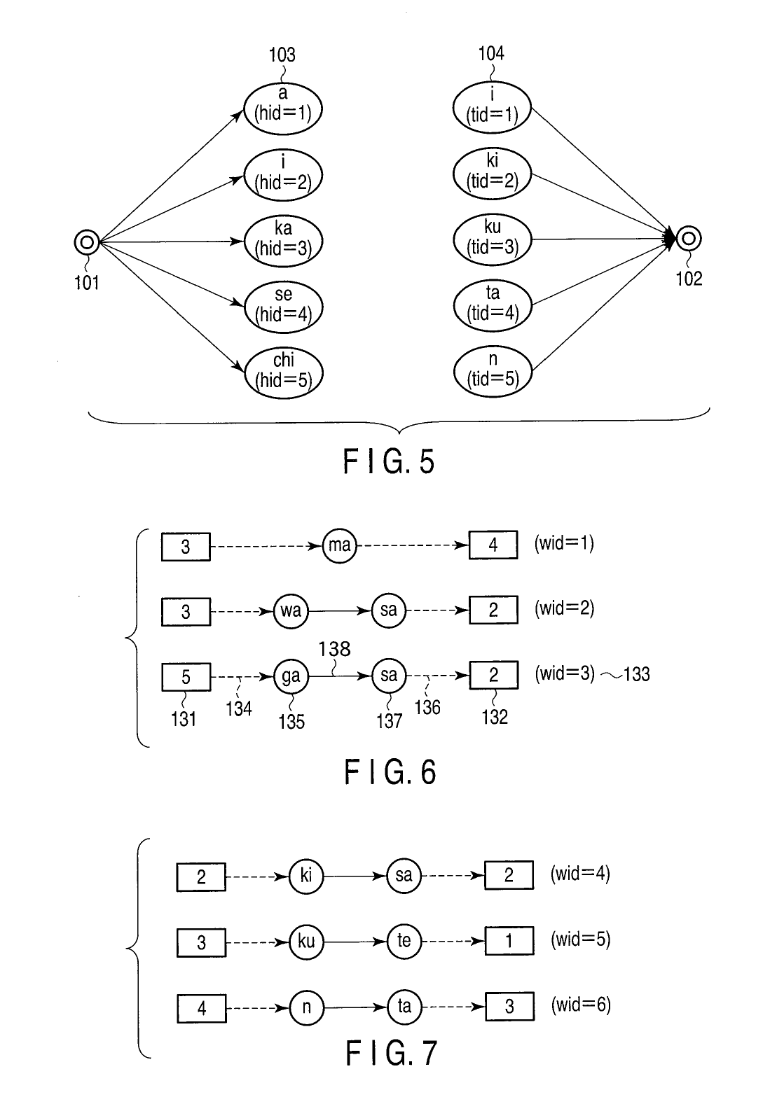

FIG. 5 shows an example of a word head portion and a word tail portion. In FIG. 5, the head node (101 in the Figure) indicates a node in the initial condition and the tail node (102 in the Figure) indicates a node in the final condition. In FIG. 5, five labeled child nodes (103 in the Figure) in the initial condition are “word head portion nodes” and five labeled parent nodes in the final condition (104 in the Figure) are “word tail portion nodes”. An identifier “hid” indicates a word head portion node identifier and another identifier “tid” indicates a word tail portion node identifier.

As evident from FIG. 5, the word head portion is a tree structure network. On the other hand, the word tail portion is a tree structure network directed in a reverse direction because the tree structure is attained by reversing the direction of the arcs from the final condition node.

FIGS. 6 to 8 show an example of the vocabulary network (of the word body portion), which will be described in detail. Each vocabulary network of the examples of FIGS. 6 to 8 contains three words.

Each of the word body data in the vocabulary network constitutes a network which provides a word (or sentence) by holding information of the word head portion node and the word tail portion node to be connected and information of labels (for example, KANA letter string) not contained in the word head portion/word tail portion.

More specifically, for example, regarding a word belonging to the vocabulary network, its word body data holds identification information of the word, identification information of the word head portion node which can be connected, identification information of the word tail portion node which can be connected and a labeled node sequence (a labeled node or a sequence of labeled nodes connected by one or more directed arcs) indicating labels not contained in the word head portion/word tail portion. The directed arc indicates a connection relation of the node, that is, a connection order relation of the node and label. However, because some word is constituted of only the word head and/or the word tail, sometimes no labeled node sequence exists. Each node sequence has a linear structure having no arc for other node sequence. The word body data is called “word body network”.

In the structure of the word body network of each word shown in FIGS. 6 to 8, the rectangular node (e.g., a node 131 in the Figure) at the beginning side holds the identifier hid of the word head portion node which can be connected and the rectangular node (e.g., a node 132 in the Figure) at the ending side holds the identifier tid of the word tail portion node which can be connected. An identifier “wid” indicates the identifier of the word. A dotted line arc (e.g., an arc 134 in the Figure) on the beginning side indicates that in a word having the word identifier wid (e.g., a wid 133 in the Figure) held by the arc, connection from the word head portion node indicated by hid held by the head node (hid holding node) the word body network (e.g., a node 131 in the Figure) at a starting point of the arc to the “word body portion node” (e.g., an node 135 in the Figure) indicated by an end point of that arc is achieved. The dotted line arc (e.g., an arc 136 in the Figure) on at the ending side indicates that in a word having the word identifier wid (e.g., wid 133 in the Figure) held by the arc, connection from the word body portion node (e.g., a node 137 in the Figure) indicated by the starting point of the arc to the word tail portion node indicated by tid held by the tail node (tid holding node) of the word body network (e.g., a node 132 in the Figure) at the end point of the arc is achieved. A part (e.g., a node 135, an arc 138 and a node 137 in the Figure) pinched by the two arcs (e.g., arcs 134 and 136 in the Figure) is a labeled node sequence which constitutes the word body network. Each node of the word body network can be identified using the identifier nid of the node (not shown).

The hid holding node (e.g., 131 in the Figure), the tid holding node (e.g., 132 in the Figure) and the arcs (e.g., 134, 136 in the Figure) indicated with the dotted lines are not just a node and arc of the word body network but information (data) attached to the word body network of each word, in practice. Thus, those may be called “connection information” (with word head portion node/word tail portion node).

In FIGS. 6 to 8, the vocabulary network (1) exemplified in FIG. 6 expresses “ka-ma-ta” (wid=1), “ka-wa-sa-ki” (wid=2) and “chi-ga-sa-ki” (wid=3).

The vocabulary network (2) exemplified in FIG. 7 expresses “i-ki-sa-ki” (wid=4), “ka-ku-te-i” (wid=5) and “se-n-ta-ku” (wid=6).

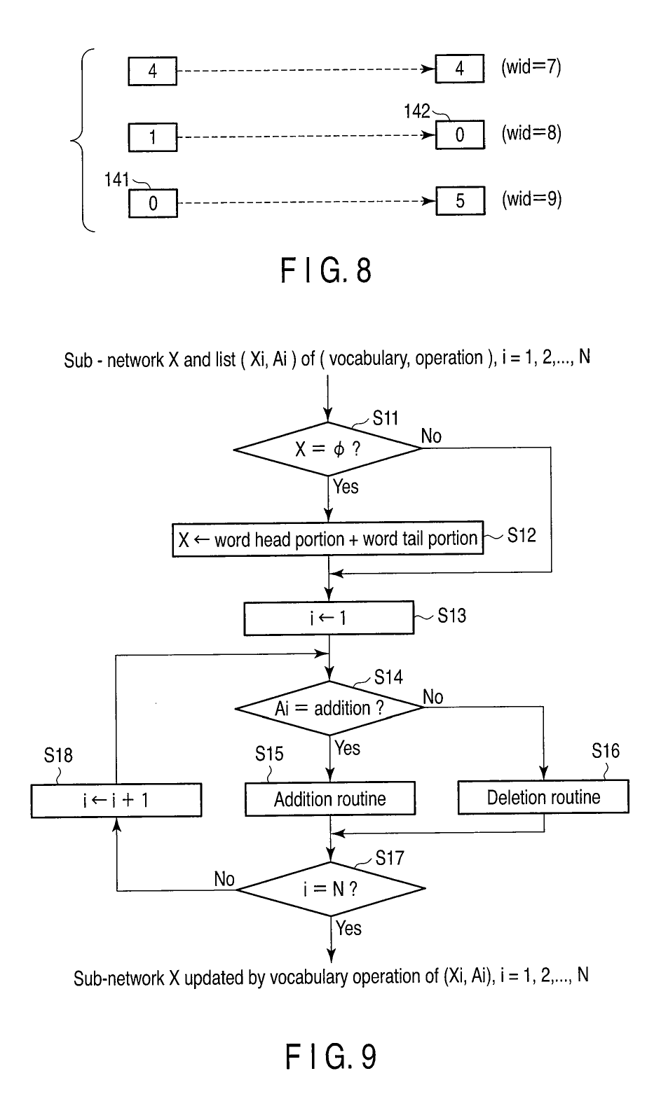

The vocabulary network (3) exemplified in FIG. 8 expresses, for example, a place name “se-ta” (wid=7), “a” (wid=8) and “n” (wid=9). Those are examples that no word body portion node of the word exists (or all label(s) of the word is contained in the word head portion and/or the word tail portion). The identifier “0” held by the hid holding node (141 in the Figure) of FIG. 8 indicates the initial condition node (head node or route node) of the word head portion and the identifier “0” held by the tid holding node (142 in the Figure) of FIG. 8 indicates the final condition node (tail node or leaf node) of the word tail portion.

FIG. 5 exemplifies a word head portion and a word tail portion corresponding to the examples of FIGS. 6 to 8.

Referring to FIG. 5, as for the word head portion, this tree structure holds a KANA letter “ka” at the word head common to the vocabulary network (1) of FIG. 6 and the vocabulary network (2) of FIG. 7, a KANA letter “se” common to the vocabulary network (2) of FIG. 7 and the vocabulary network (3) of FIG. 8 and first letters of all other words contained in the three vocabulary networks. As for the word tail portion, this tree structure holds a KANA letter “ki” common to the vocabulary network (1) and the vocabulary network (2) and last letters of all other words contained in the three vocabulary networks.

In the example of FIG. 5, Each labeled node of the word head portion nodes and the word tail portion nodes holds only a KANA letter. However, the number of letters held by the labeled node is not limited to a letter. For example, a string of two KANA letters of “sa-ki” (that is, “sa-ki” common to “ka-wa-sa-ki”, “chi-ga-sa-ki”, “i-ki-sa-ki”) may be held in the word tail portion node.

Next, referring to FIGS. 6 to 8, it is indicated that the word body portion node “ma” of the word body network of the word identifier wid=1 in the vocabulary network (1) is connected to the word head portion node of hid=3 (a node labeled with “ka” in FIG. 5) and the word tail portion node of tid=4 (a node labeled with “ta” in FIG. 5). Thus, by connecting this word body network to the word head portion node and the word tail portion node, a word “ka-ma-ta” is registered in the grammar network.

Because words composed of two or less KANA letters like words of the vocabulary network (3) are included in the word head portion node and/or the word tail portion node, no KANA letter of the word body network exists depending on a case. In such a case, the word body network of each word is only connection information from the node of the word head portion to the node of the word tail portion. For example, in case of a word of wid=7, the word head portion node (“se” in FIG. 5) of hid=4 and the word tail portion node (“ta” in FIG. 5) of tid=4 are connected to each other directly so as to obtain a word “se-ta”.

In this example, each node has a single KANA letter as a node label. However, the node is not limited to this example but the node label may be a single KANA letter or a larger unit than a single KANA letter (for example, word, word string and the like) or a smaller unit than a single KANA letter (for example, phoneme, status ID of HMM) or those factors may be mixed.

Next, an example of the processing procedure of generating a grammar from the grammar frame, word head portion, word tail portion and word body portion by carrying out an instructed operation (any one of addition and deletion) to an instructed vocabulary will be described.

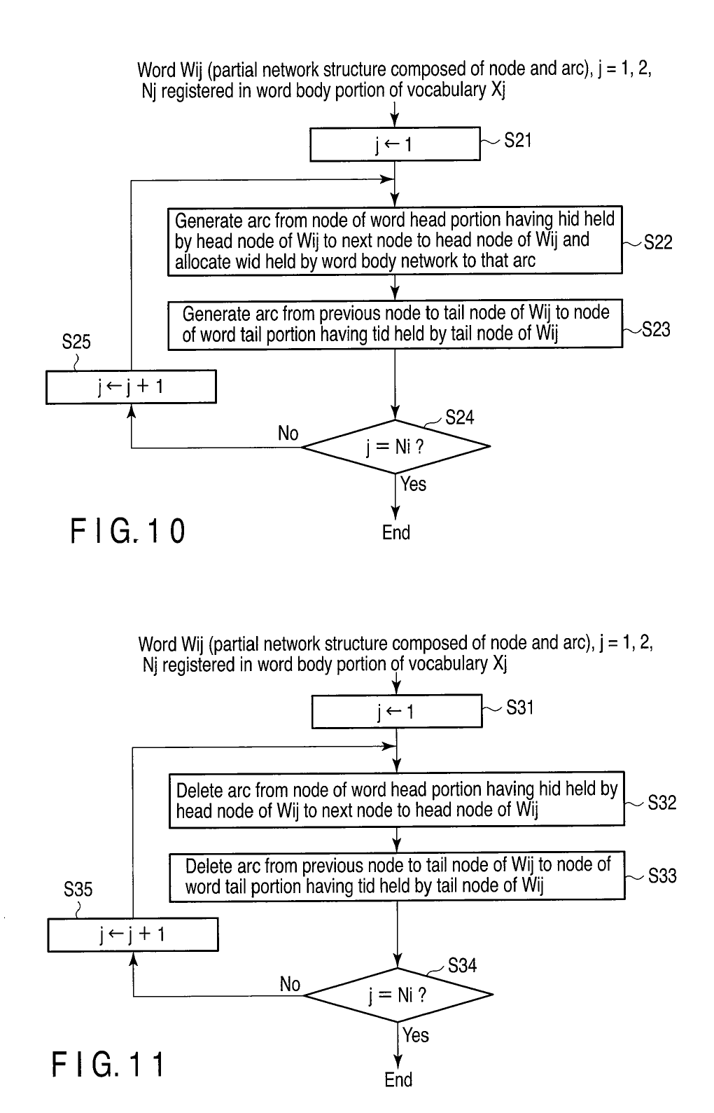

There will now be described an example of the flow chart in this case referring to FIGS. 9 to 11. FIG. 10 shows an example of the processing procedure of the addition routine of step S15 in FIG. 9 and FIG. 11 shows an example of the processing procedure of deletion routine of step S16 in FIG. 9.

A sub-network X (see FIG. 4) and a list of a group of a vocabulary Xᵢ and an operation Aᵢ to that vocabulary Xᵢ (Xᵢ, Aᵢ) are inputted. Here, N is the number of vocabularies, where i=1, 2, . . . N.

First, if the sub-network of the grammar frame is X=φ for an initial vocabulary operation, namely, if no word is registered for X (step S11), an initial setting processing (step S12) is carried out. That is, in the initial setting processing, the initial condition node (101 in FIG. 5) of the word head portion is removed from the sub-network X and instead, it is connected to the initial condition node of the grammar frame (81 in FIG. 4). At the same time, the final condition node (102 in FIG. 5) of the word tail portion is removed and instead, it is connected to the final condition node (82 in FIG. 4) of the grammar frame. Consequently, two separated networks are provided.

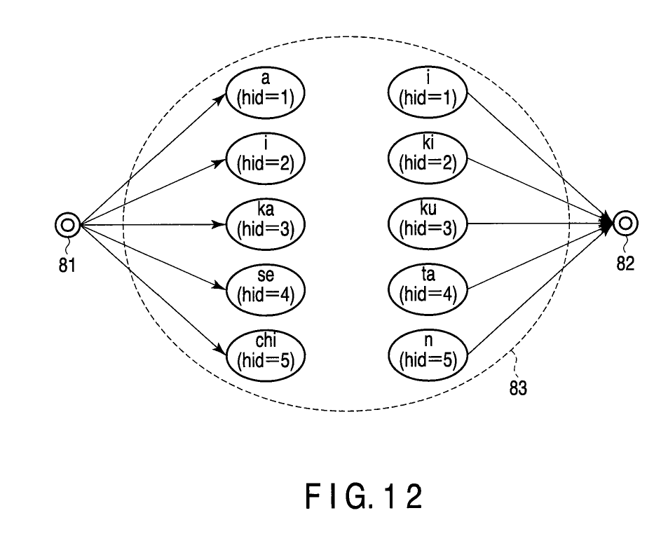

FIG. 12 shows a network structure of the grammar frame at this time. An area indicated with the dotted lines in FIG. 12 (83 in the Figure) indicates the sub-network X.

The reason why the initial condition node of the word head portion and the final condition node of the word tail portion are removed from the X and it is connected to the initial condition node and the final condition node of the grammar frame as indicated in the initial setting processing of step S12 is to avoid overlapping of the initial condition node and the final condition node when the word head portion and the word tail portion are connected and not any essential operation.

If NO is selected in step S11, step S12 is skipped.

Next, in step S13, i is set to 1. After that, this processing is repeated until N vocabularies are processed completely.

First, in step S14, an operation Aᵢ to ith vocabulary Xᵢ is determined and in case of addition, addition routine is executed in step S15. On the other hand, in case of deletion, deletion routine is executed in step S16. Then, unless i=N in step S17, i is incremented by 1 in step S18 and the procedure is returned to step S14, in which an operation to a next vocabulary is executed.

Finally, if i=N in step S17, the operation is ended. Consequently, a new sub-network X is generated.

Next, the addition routine (S15 in FIG. 9) shown in FIG. 10 will be described.

In the addition routine, the addition operation is executed to the word body networks (node and arc structures) of all words belonging to the vocabulary Xᵢ. Here, the number of the words belonging to the vocabulary Xᵢ is expressed as Nᵢ and each word belonging to the vocabulary Xᵢ is expressed as Wᵢⱼ (j=1, 2, . . . Nᵢ).

First, in step S21, j is set to 1. After that, this processing is repeated until Nᵢ words are processed completely.

In step S22, an arc from the word head portion node having the word head portion identifier hid held by the head node of word body network of jth word Wᵢⱼ to a next node to the head node of the word Wᵢⱼ is generated. A word identifier wid held by the word body network is allocated to the generated arc.

In step S23, an arc from a previous node to the tail node of word body network of the word Wᵢⱼ to the word tail portion node having the word tail portion identifier tid held by the tail node is generated.

It is permissible to execute either step S22 or step S23 first or execute them at the same time.

Then, unless j=N in step S24, j is incremented by 1 in step S25 and the procedure is returned to step S22, in which the addition processing to a next word is executed.

Finally, if j=Nⱼ in step S24, this addition routine is terminated.

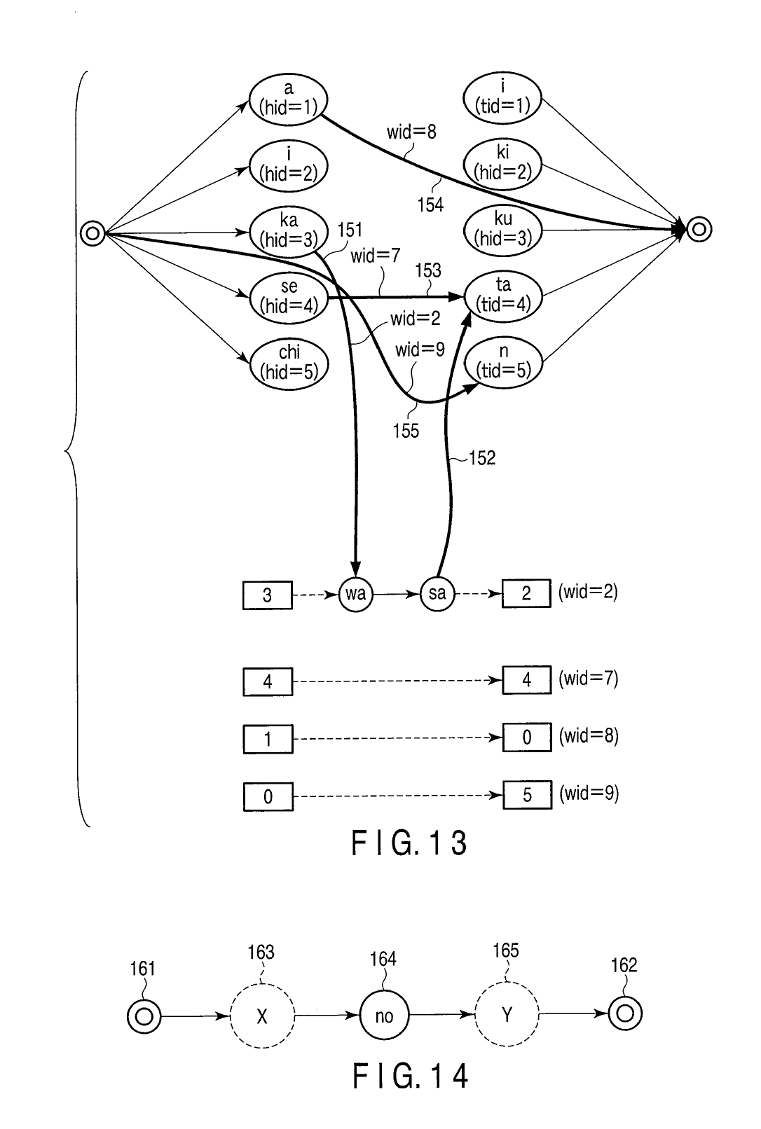

As an example, FIG. 13 shows a network structure of the grammar frame in a situation in which the words “ka-wa-sa-ki”, “se-ta”, “a”, “n” (see FIGS. 6 to 8) are connected to the word head portion/word tail portion (see FIG. 5). In FIG. 13, heavy lines (151 to 155 in the Figure) indicate an arc generated by the addition operation.

Next, the deletion routine (step S16 in FIG. 9) shown in FIG. 11 will be described.

In the deletion routine, the deletion operation is executed to the word body networks of all the words Wᵢⱼ belonging to the vocabulary Xᵢ.

First, in step S31, j is set to 1. After that, this processing is repeated until Nⱼ words are processed completely.

In step S32, the arc from the word head portion node having the word head portion identifier hid held by the head node (hid holding node) of word body network of jth word Wᵢⱼ to a next node to the head node of the word Wᵢⱼ is deleted.

In step S33, the arc from a previous node to the tail node (tid holding node) (of word body network of the word Wᵢⱼ to the word tail portion node having the word tail portion identifier tid held by the tail node of the word Wᵢⱼ is deleted.

It is permissible to execute either step S32 or step S33 first or execute both of them at the same time.

Then, unless j=N in step S34, j is incremented by 1 in step S35 and the procedure is returned to step S32, in which the deletion operation to a next word is executed.

Finally, if j=Nⱼ in step S34, this deletion routine is terminated.

By the above-described addition/deletion processing, the sub-network X of the grammar frame is updated and upon next addition/deletion operation, further addition/deletion operation is carried out to this updated sub-network X.

The grammar frame generated by the addition/deletion processing is registered in the speech recognition unit 13 as a grammar network for speech recognition. The speech recognition unit 13 executes speech recognition on inputted voice using this grammar network. A specific method for the speech recognition using the grammar network has been disclosed in Stepehn E. Levinson: “Structural Methods in Automatic Speech Recognition”, Proceedings of the IEEE. Vol. 73. No. 11. pp. 1625-1650. November 1985 in detail although description thereof is omitted here.

If only the vocabulary network (1) and the vocabulary network (2) are used in the examples of FIGS. 6 to 8, any node which is connected to the word head portion node “a” in FIG. 5 does not exist without the initial condition node 101 and any node which is connected to the word tail portion node “n” in FIG. 5 does not exist without the final condition node 102 (the node “a” and the node “n” are necessary when the vocabulary network (3) is used). As evident from this, depending on a combination of the vocabularies, there exists any node which cannot reach the nodes of the word body network if child/parent nodes are traced successively from that node. Such a node is an unnecessary node at the time of speech recognition and thus, each node of the word head portion nodes/word tail portion nodes is provided with a flag indicating whether or not it is necessary for the speech recognition and a node necessary for the speech recognition is set to 1 while a node unnecessary is set to 0. Then, at the time of the speech recognition, only nodes whose flag is set to 1 may be used.

By using the word head portion and the word tail portion as described above, common parts of plural vocabularies are merged while each vocabulary holds only the word body portion. Consequently, the memory size required for memorizing the vocabulary can be reduced as compared with conventional methods.

Addition of the vocabulary is carried out by only connecting the word body to an adaptive word head/word tail and deletion of the vocabulary is carried out by only disconnecting the connection between the word head/word tail and the word body. Thus, a relatively quick addition and deletion of the vocabulary is possible.

In this embodiment, preference is given to clarifying an essential quality thereof rather than indicating an effect of memory reduction and as a specific example, a simple example that the number of words is small and both the word head portion and word tail portion have a single KANA letter has been described. Needless to say, if the number of words in the vocabulary is increased or the number of characters shared by the word head portion/word tail portion is increased, the effect of memory reduction appears evidently.

As described above, this embodiment enables the quick vocabulary addition/deletion operations and at the same time, merger between the vocabulary networks (to reduce the memory size necessary therefor).

### Second Embodiment

Hereinafter, the second embodiment will be described about mainly different points from the first embodiment.

This embodiment is different from the first embodiment in that it does not need to have any grammar frame as an independent data.

In case of a simple sentence pattern in which a grammar frame thereof contains only a sub-network X like the first embodiment, the grammar frame does not need to be stored in the grammar storage unit 11. That is, it is evident from the above description that even if the grammar frame is not stored as data, by generating a grammar network by adding/deleting the vocabulary directly to the word head portion/word tail portion, the same grammar network as when the grammar frame is used can be obtained. The addition/deletion of the vocabulary is enabled by the same processing procedure as in FIGS. 9 to 11.

According to this embodiment, the grammar network can be built up like the first embodiment and the same effect as the first embodiment can be obtained.

### Third Embodiment

Hereinafter, the third embodiment will be described about mainly different points from the first embodiment.

Although the first embodiment has been described about an example that only a sub-network for operating the vocabulary exists, this embodiment will be described about a case of using a grammar frame containing plural sub-networks.

FIG. 14 shows an example of the grammar frame containing plural sub-networks. FIG. 14 is an example of a grammar frame which expresses a sentence pattern of “X-no-Y” (no). This example is also an example contains the vocabulary fixing node.

In FIG. 14, the head node (161 in the Figure) indicates an initial condition node and the tail node (162 in the Figure) indicates a final condition node. X (163 in the Figure) and Y (165 in the Figure) are sub-networks. That is, this grammar frame indicate that the vocabulary is set in each of the sub-networks X and Y. The node labeled with “no” (164 in the Figure) is a vocabulary fixing node and this example indicates that X and Y are connected with the node “no”.

In case of FIG. 14, the grammar editing unit 12 executes vocabulary operation (addition operation/deletion operation) to each of the sub-networks X and the sub-network Y.

Regarding the word head portion, this embodiment needs one or more word head portions for X and one or more word head portions for Y. Likewise, Regarding the word tail portion, one or more word tail portions for X and one or more word tail portions for Y are needed. The configuration of the word head portion/the word tail portion for X/Y may be the same as in FIG. 5 and each of them is part of a network containing a word head/word tail common to two or more vocabularies.

As for the word body portion, there is a feature added to FIGS. 6 to 8. That is, the vocabularies for use include a vocabulary for use in both the sub-networks X and Y and a vocabulary for use in only any one of X and Y. Therefore, according to this embodiment, the head node/tail node of the word body network which expresses each word of the word body portion need to hold the identifier hid of a connectable word head portion node/the identifier tid of a connectable word tail portion node like the first embodiment and additionally, an identification information (sid) for identifying a sub-network which it can be connected to.

If a certain vocabulary can be used for both the sub-networks X and Y in the example of FIG. 14, its head node/tail node which indicate a connection with the word head portion/word tail portion hold both the identifier hid of the word head portion node and identifier tid of the word tail portion node which can be connected when used for the sub-network X/the identifier tid of the word tail portion node and the identifier hid of the word head portion node which can be connected when used for the network Y/the identifier tid of the word tail portion.

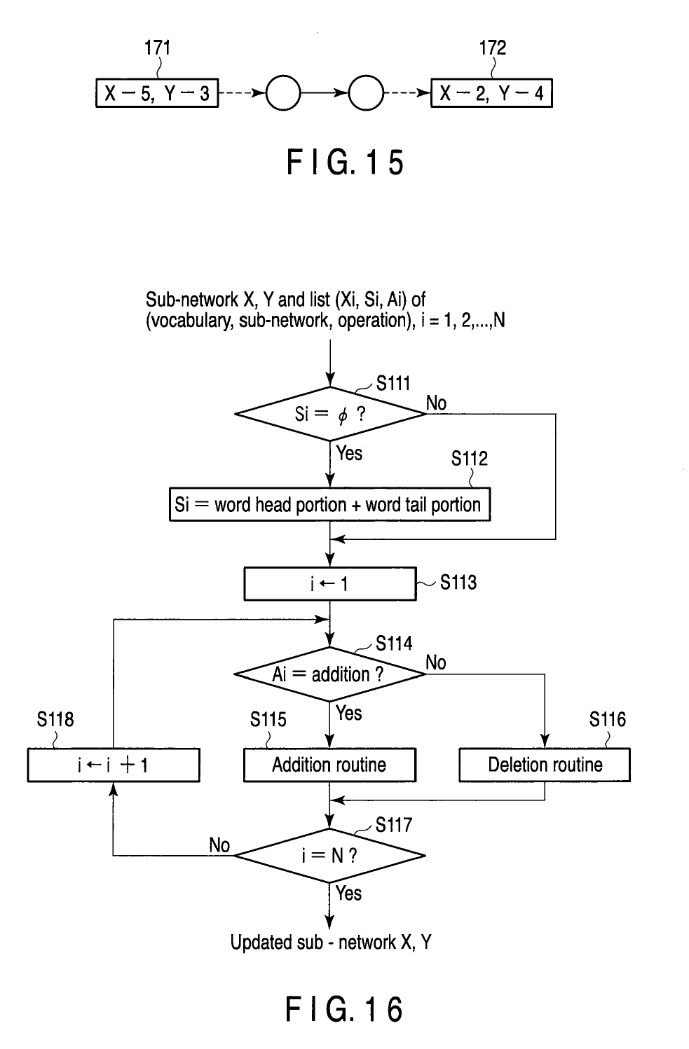

FIG. 15 shows an example of the word structure of the word body network of this case.

The example of FIG. 15 shows that if this word body network is used for the sub-network X, the word head portion node of hid=5 and the word tail portion node of tid=2 are connected and if it is used for the sub-network Y, the word head portion node of hid=3 and the word tail portion node of tid=4 are connected (171, 172 in the Figure).

The grammar generation procedure of the grammar editing unit 12 needs a group of three comprised of the vocabulary, a sub-network to be connected (X or Y in this example) and operation {vocabulary, connecting sub-network, operation} instead of the group of the vocabulary and operation as described in FIGS. 9 to 11.

Next, an example of the processing procedure of generating the grammar from the grammar frame, word head portion, word tail portion and word body portion by executing an instructed operation (any one of addition and deletion) to an instructed vocabulary and connecting sub-network will be described.

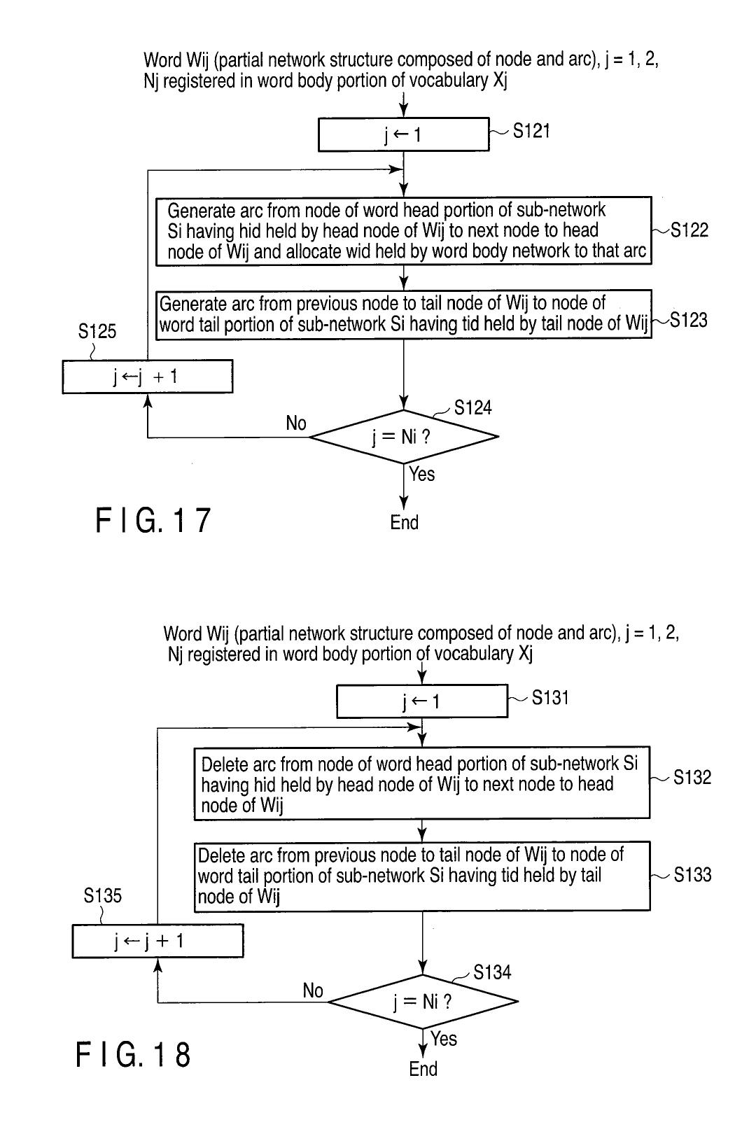

There will now be described an example of the flow chart in this case referring to FIGS. 16 to 18. FIG. 17 shows an example of the processing procedure for an addition routine of step S115 of FIG. 16 and FIG. 18 shows an example of the processing procedure of an deletion routine of step S116 of FIG. 16.

The sub-networks X, Y (see FIG. 14), and a list of a group of a vocabulary Xᵢ, a sub-network Sᵢ to which the vocabulary should be connected and an operation Aᵢ to the vocabulary Xᵢ (Xᵢ, Sᵢ, Aᵢ) are inputted. Here, N is the number of vocabularies, where i=1, 2, . . . N.

The flow of FIG. 16 is basically the same as the flow of FIG. 9. However, the initial setting processing of step S112 is as follows. In the example of FIG. 14, for the sub-network X, the initial condition node of the word head portion is removed therefrom and instead, the initial condition node (161 in FIG. 14) of the grammar frame is connected thereto. At the same time, the final condition node of the word tail portion is removed and instead, the vocabulary fixing node (164 in FIG. 14) of the grammar frame is connected. Likewise, for the sub-network Y, the initial condition node of the word head portion is removed therefrom and instead the vocabulary fixing node of the grammar frame is connected. At the same time, the final condition node of the word tail portion is removed and instead, the final condition node (162 in FIG. 14) of the grammar frame is connected. Of course, this operation is not an essential operation like the first embodiment.

Next, the addition routine (S115 in FIG. 16) shown in FIG. 17 will be described.

The addition routine of FIG. 17 is basically the same as the addition routine of FIG. 10. In the addition routine of FIG. 17, the addition operation is executed to a sub-network instructed by Sᵢ of plural sub-networks.

Next, the deletion routine (S116 in FIG. 16) shown in FIG. 18 will be described.

The deletion routine of FIG. 18 is basically the same as the deletion routine of FIG. 11. However, the deletion routine of FIG. 18 executes deletion operation for a sub-network specified by Sᵢ of plural sub-networks.

As evident from the above description, generation of a quick grammar network with an excellent memory efficiency is possible in case where a grammar frame in which plural sub-networks exist is used as well as in case where a grammar frame in which a single sub-network exists. Further, the same thing can be done in case where plural grammar frames are provided and in this case also, it is evident that the same effect can be obtained.

Because the grammar of this embodiment is a simple sentence pattern “X-no-Y”, the grammar frame does not need to be stored in the grammar storage unit 11 like the second embodiment. If no grammar frame is provided as an independent data, after each of X and Y is generated by the grammar editing unit 12 according to the processing procedure of FIGS. 16 to 18, the vocabulary fixing node indicating a KANA letter “no” is inserted in between the sub-network X and the sub-network Y so as to generate a grammar network. In case where the grammar network can be generated regularly, the grammar frame is unnecessary.

### Fourth Embodiment

Hereinafter, the fourth embodiment will be described about mainly different points from the first to third embodiments.

Generally, for speech recognition, the tree structure network which is a special one is often used as the vocabulary network. In case where the tree structure network is used, the vocabulary network is so constructed that the word head common to the plural words is shared but the word tail is not shared. In this case, the word tail portion is unnecessary. The word body of a individual word or sentence contained in the vocabulary is picked up by removing the word head (word head side part) from that word or sentence.

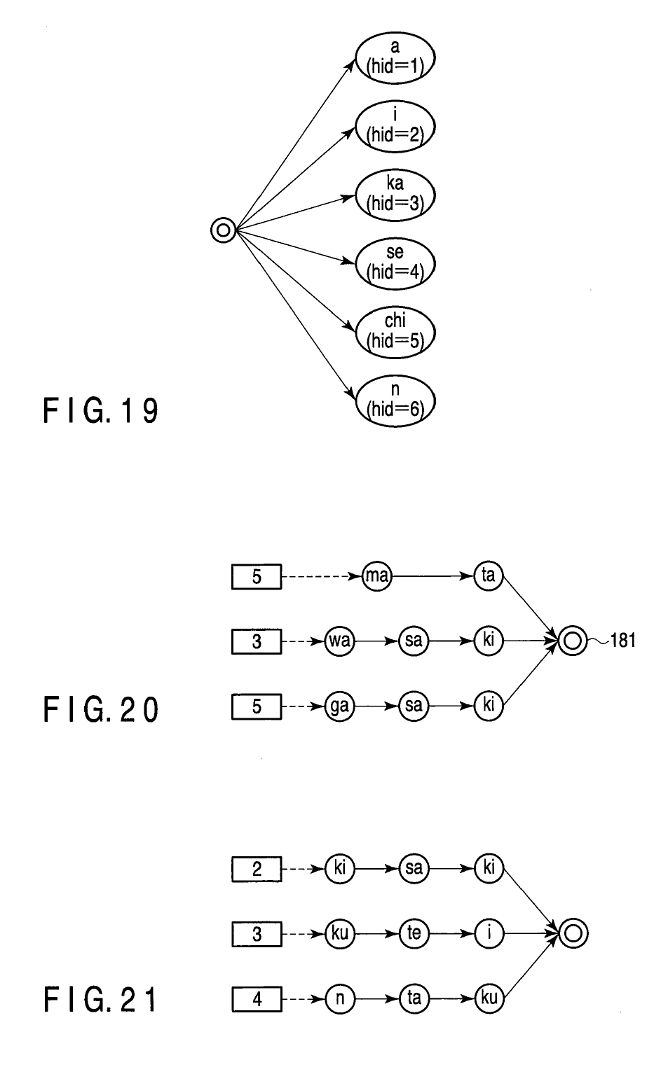

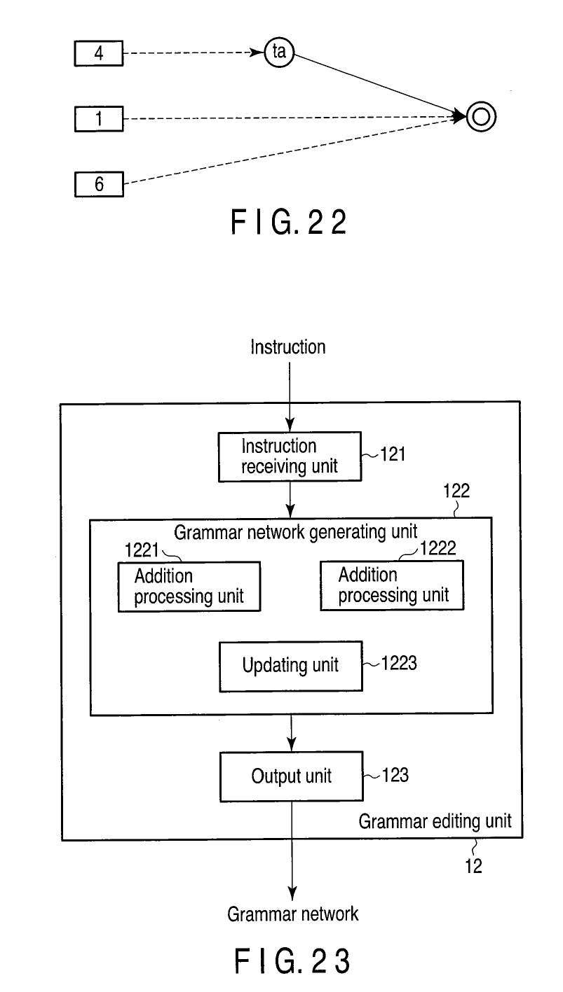

FIGS. 19 to 22 show an example that the vocabularies of FIGS. 5 to 8 are achieved with the tree structure network. FIG. 19 shows an example of the word head portion and FIGS. 20 to 22 show an example of the vocabulary network. In the examples of FIGS. 19 to 22, no word tail portion exists as compared with the examples of FIGS. 5 to 8 and instead, the tail of the word body is connected to the final condition node (181 in the Figure).

The grammar frame may be the same as in the above-described embodiments (see FIGS. 4 and 14).

If the tree structure is used, it is evident that the grammar editing unit 12 can generate the grammar by the same processing if the operation to the word tail portion is canceled in the above described embodiments. More specifically, the flow chart for operating the vocabulary may be obtained by removing the operation to the word tail portion (step S23 in FIG. 10/step S33 in FIG. 11, step S123 in FIG. 17/step S133 in FIG. 18) from the flow chart of the above described embodiments.

Further, if the grammar frame is a simple sentence pattern like in the above respective embodiments, no grammar frame needs to be stored in the grammar storage unit 11.

In case where no word tail portion is provided like the tree structure, the same memory reduction effect as in the above respective embodiments can be obtained by sharing the word head.

### Fifth Embodiment

Hereinafter, the fifth embodiment will be described about mainly different points from the first to fifth embodiments.

Although in the above embodiments, the example that the label which the node of the vocabulary network is of a single KANA letter has been described, the node label is not limited to this example, but the node label may be of a single KANA letter or a larger unit than the single KANA letter (for example, word, word string and the like) or a smaller unit than a single KANA letter (for example, phoneme, status ID of HMM).

Here, a case where the node of the vocabulary network is in the HMM status in the above respective embodiments will be described.

Actually, the vocabulary network and grammar network are often constituted of the hidden Markov Model (HMM). According to a generally used method, the word is constituted of phoneme HMM joint and each node of the grammar network indicates a status of the phoneme HMM. More specifically, this point has been disclosed in, for example, “Lawrence Rabiner, Biing-Hwang Juang: “Fundamentals of Speech Recognition”, Prentice Hall International Editions, 1993”.

If the above-described network is used in the first to fourth embodiments, its operation is not essentially different from the above description and in the above description, the node label is replaced with the status of the phoneme HMM instead of the KANA letter. Thus, according to this embodiment, the word head portion/word tail portion and the word body portion are constituted like the above embodiments, so that addition/deletion of the vocabulary can be carried out efficiently.

### Sixth Embodiment

Hereinafter, the sixth embodiment will be described about mainly different points form the first to fifth embodiments. In the above embodiments, the word head portion/word tail portion are specified and fixed preliminarily.

When user actually uses the speech recognition apparatus having the grammar frame of the first embodiment, assume that user A often uses a situation in which the sub-network X is constituted of vocabulary X1 and vocabulary X2 while user B often uses a situation in which the sub-network X is constituted of vocabulary X3, vocabulary X4 and vocabulary X5. In such a case, if user A uses the word head portion/word tail portion in which the nodes suitable for the vocabulary X1 and the vocabulary X2 are shared while user B uses the word head portion/word tail portion in which the nodes suitable for the vocabulary X3, the vocabulary X4 and the vocabulary X5 are shared instead of using the word head portion/word tail portion provided preliminarily as they are, the memory efficiency of the word head portion/word tail portion is improved.

In addition to the above mentioned example, by updating the sharing of the nodes of the word head portion/word tail portion to that suitable for vocabulary for use as required, the memory efficiency is further improved instead of using the fixed word head portion/word tail portion as they are. In this embodiment, the updating method of the word head portion/word tail portion will be described. The updating processing of the word head portion/word tail portion may be automatically at an appropriate timing, for example, when user gives an updating instruction directly to the speech recognition apparatus or when the speech recognition apparatus turns into a specific condition.

The configuration of the speech recognition apparatus of this embodiment is the same as in FIG. 1.

FIG. 23 shows an example of the internal configuration of the grammar editing unit 12 of this embodiment. In the grammar editing unit 12 of this embodiment having the structure of FIG. 2, the grammar network generating unit 122 further contains an updating unit 1223.

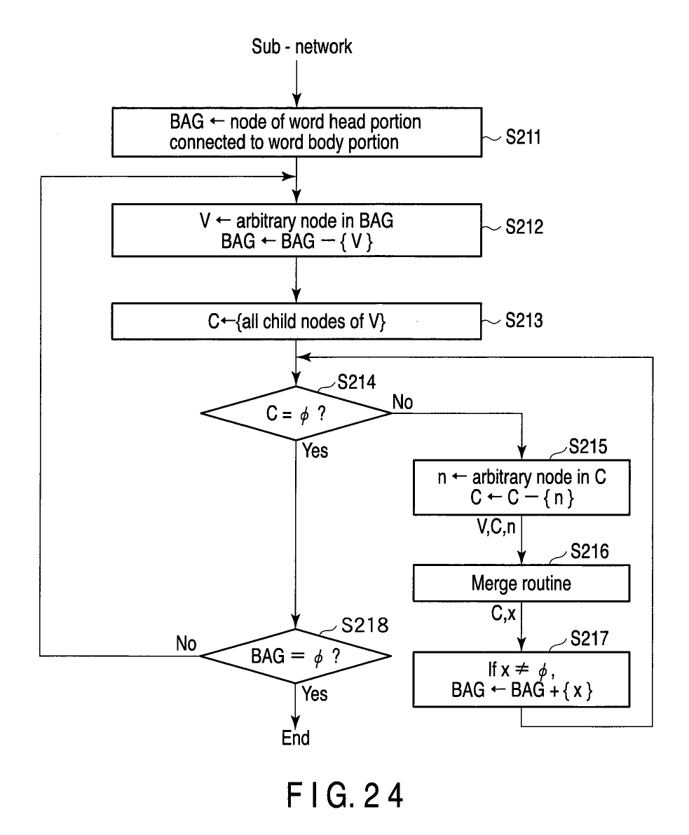

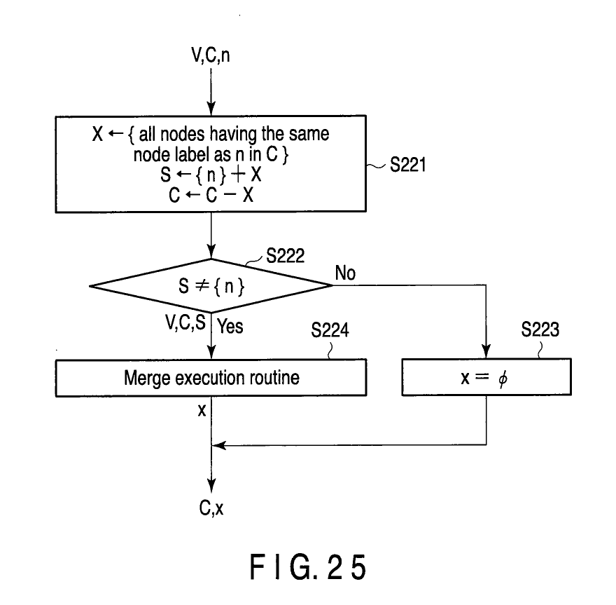

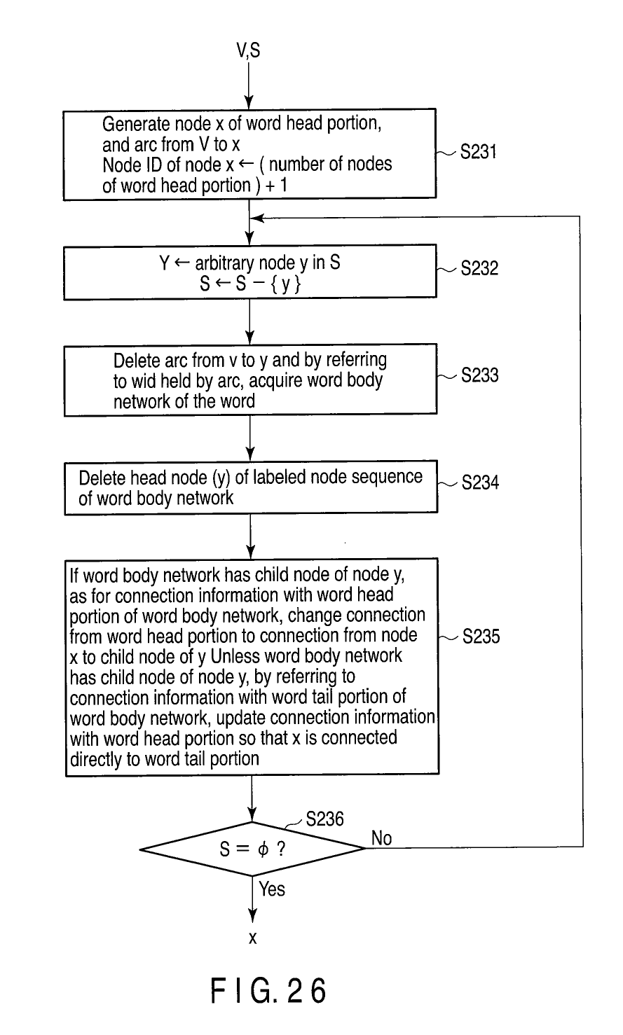

Hereinafter, an example of the processing procedure for updating the word head portion in the updating unit 1223 will be described. FIGS. 24 to 26 show an example of the flow chart in this case. FIG. 25 shows an example of the processing procedure of the merge routine of step S217 of FIG. 24 and FIG. 26 shows an example of the processing procedure of the merge execution routine of step S224 of FIG. 25.

As a premise for execution of this processing, assume that the sub-network X of the grammar frame is empty (X≠φ), that is, a vocabulary is set. Further, as for the word head portion, assume that the word head portion node identifier hid of the initial condition node is 0 and the identifier hid is allocated to each node of the word head portion except in the initial condition node with a sequence number beginning from 1. Likewise, as for the word tail portion, assume that the word tail portion node identifier tid of the final condition node is 0 and the identifier tid is allocated to each node of the word tail portion except in the initial condition with a sequence number beginning from 1.

In the processing procedure of FIG. 24, the sub-network is inputted.

First in step S211, of the nodes of the word head portion of that sub-network, nodes connected to the word body portion are registered in BAG. Here, the nodes connected to the word body portion can be acquired from connecting information with the word head portion of each word belonging to the word body portion connected to the sub-network.

After that, this processing is repeated until all the nodes registered in the BAG are processed (that is, until the BAG becomes empty (φ) in step S218).

First, in step S212, an arbitrary node V is picked out of the BAG.

Next, in step S213, all child nodes of the picked node V are acquired and those are regarded as a set C. In step S214, whether or not the C is empty is determined. Unless the C is empty, the procedure proceeds to step S215, in which an arbitrary node n is picked out of the C. In step S216, with the node V, assembly C and node n inputted, the merge routine described later is executed. The assembly C is updated by the merge routine. In step S217, if there is a node x newly generated by the merge routine, it is added to the BAG and the procedure is returned to step S214.

In step S218, the BAG is investigated and unless BAG=φ, the procedure is returned to step S212, in which an operation to a next node V is executed.

Finally, if BAG=φ in step S218, the update processing of this word head portion is terminated.

In viewpoints of actual application, if the processing is repeated until the BAG becomes empty in step S216, it takes a tremendous amount of time, thereby producing an inconvenience that user cannot use the speech recognition apparatus in this while. For the reason, as a stop condition of step S218, it is permissible to use a condition that if processing from step S212 to step S217 is repeated over predetermined times, the processing is ended even if the BAG is not empty or a condition that if X or more seconds elapse after the update processing of the word head portion is started, the processing is ended even if the BAG is not empty (φ).

Next, the merger routine (step S327 in FIG. 24) shown in FIG. 25 will be described.

In the processing procedure of FIG. 25, the node V, node assembly C and node n are inputted.

First, in step S221, assume that X is a set of all nodes having the same node label as n in the C, such that

S←{n}+X

C←C−X.

If in step S222, no node having the same node label as a node n exists, that is, S={n}, the procedure proceeds to step S223. In step S223, with an output x, φ indicating that no node exists is set up.

If in step S222, S≠{n}, that is, a node having the same node label as n exists, the procedure proceeds to step S224. In step S224, the merge execute routine is executed and as its output, a node x is obtained.

Next, the merge execute routine (step S224 of FIG. 25) will be explained.

In the processing procedure of FIG. 26, in step S231, a node x of the word head portion is generated and an arc is generated to x from V which is a parent node of a node group of S. In step S231, the node identifier hid of the node x is set to a number of nodes of the word head portion+1.

After that, this processing is repeated until all the nodes of S are processed (that is, until S becomes empty (φ) in step S236).

First, in step S232, an arbitrary node y is picked out of S. Because V is a node of the word head portion and y is a node of the word body network of a certain word, an arc from V to y has a word identifier wid like an arc indicated with a heavy line in FIG. 13 (151 to 155 in FIG. 13). Therefore, the word body network of that word can be obtained with this word identifier wid. The node y is a labeled node at the head of the labeled node sequence of the word body network of the word (e.g., 135 in FIG. 6).

Next, in step S233, the arc from V to y is deleted and by referring to the word identifier wid held by that arc, the word body network of that word is obtained.

Next, in step S234, the labeled node y at the head of the labeled node sequence of the word body network is deleted.

Then, in step S235, the connection information with the word head portion of the word is updated. That is, if a child node of the node y exists in the word body portion, as regards the connection information with the word head portion of the word body network, a connection from the word head portion is changed to a connection from a new node x to the child node (e.g., 137 in FIG. 6) of the node y (e.g., 135 in FIG. 6). Unless the child node of the node y exists in the word body (that is, if the word body is nothing but y), by referring to the connection information with the word tail portion of the word body network, the connection information with the word tail portion is updated so that the new node x is connected directly to the word tail portion (see “se-ta” of the vocabulary network (3) of FIG. 8).

Unless S=φ in step S236, the procedure is returned to step S232, in which a processing to a next node is executed.

Finally, if S=φ in step S236, this merge execute routine is terminated.

Consequently, of the word body portions, nodes having the same node label are merged and assembled as the node of the word head portion (node x in step S231), whereby the memory efficiency being improved.

Although the above-mentioned processing is a processing for a single sub-network, if a plurality of the sub-networks exist, the same processing may be executed to each of the sub-networks.

If speaking of a timing of executing the updating of the word head portion, when a combination of vocabularies having a high availability is set in the sub-network, it is preferable to update the word head portion. Then, it is permissible to record combinations of the vocabularies and frequency of use thereof for each sub-network in grammar editing unit 12 and update the word head portion when the combination of the vocabularies exceeds a predetermined time in a certain sub-network.

Although the above-described processing is an update processing for the word head portion, it is evident that the same update processing is enabled to the word tail portion and a detailed description thereof is omitted.

According to this embodiment, by optimizing the word head portion/word tail portion as required, a more efficient network can be implemented.

### Seventh Embodiment

Hereinafter, the seventh embodiment will be described about mainly different points from the sixth embodiment.

As evident from the update processing procedure shown in the sixth embodiment, the update processing procedure may be started from only the initial condition/final condition of the word head portion/word tail portion so as to generate the word head portion/word tail portion by the update processing. This method is convenient because the word head portion/word tail portion do not need to be created preliminarily.

This speech recognition apparatus can be implemented by using a general purpose computer as a basic hardware. That is, the grammar editing unit and the speech recognition unit can be achieved by making a processor loaded on the computer unit execute a program. At this time, the speech recognition apparatus may be achieved by installing the program on the computer or by memorizing this program in such a memory medium as a CD-ROM, then distributing the program through a network and installing the program on the computer unit appropriately. The grammar storage unit 11 can be achieved using a memory medium such as a memory built in or attached externally to the computer unit, a hard disk, CD-R, CD-RW, DVD-RAM and DVD-R appropriately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech recognition apparatus using a grammar network which provides a set of recognition target words or sentences, comprising:
a storage unit configured to store a plurality of vocabularies, each of the vocabularies including a plurality of word body data, each of the word body data being obtained by removing a specific word head from an arbitrary word or sentence, and store at least one word head portion including a plurality of labeled nodes in order to express at least one common word head common to at least two of said plurality of vocabularies;
an instruction receiving unit configured to receive a first instruction for selecting a target vocabulary from said plurality of vocabularies and a second instruction for instructing the content of a operation to the target vocabulary;
a grammar network generating unit configured to generate, when a processing for adding the target vocabulary is instructed by the first instruction, a grammar network containing the word head portion, the target vocabulary selected by the second instruction and word head portion side connection information indicating that each of said plurality of the word body data contained in the target vocabulary is connected to a preliminarily matched one of said plurality of labeled nodes contained in the word head portion; and
a speech recognition unit configured to execute speech recognition using the generated grammar network.

2. The speech recognition apparatus according to claim 1, wherein when a processing for deleting the target vocabulary is instructed, the grammar network generating unit deletes the target vocabulary and the word head portion side connection information corresponding to the target vocabulary from the grammar network.

3. The speech recognition apparatus according to claim 2, wherein each of the word body data is constituted of a network containing a labeled node sequence, and
the speech recognition apparatus further comprises an updating unit configured to update the word head portion so as to reduce the number of the labeled nodes contained in two or more of the word body data and updates said two or more of the word body data so as to be fitted to the updated word head portion.

4. The speech recognition apparatus according to claim 3, wherein the word head portion is constituted of a network containing the labeled nodes with an initial condition node serving as a route node, and
with the initial condition of the word head portion containing only the initial condition nodes, the updating of the word head portion and the updating of the word body data are carried out.

5. The speech recognition apparatus according to claim 2, wherein the storage unit further stores a grammar frame which is a model of the grammar network, defining at least one of the portions in which the vocabulary is variable in the grammar network, and
the grammar network generating unit generates the grammar network with the grammar frame used as a model.

6. The speech recognition apparatus according to claim 5, wherein each of the word body data is constituted of a network containing a labeled node sequence, and
the speech recognition apparatus further comprises an updating unit configured to update the word head portion so as to reduce the number of the labeled nodes contained in two or more of the word body data and updates said two or more of the word body data so as to be fitted to the updated word head portion.

7. The speech recognition apparatus according to claim 6, wherein the word head portion is constituted of a network containing the labeled nodes with an initial condition node serving as a route node, and
with the initial condition of the word head portion containing only the initial condition nodes, the updating of the word head portion and the updating of the word body data are carried out.

8. The speech recognition apparatus according to claim 1, wherein each of the word body data is obtained by removing a specific word head and a specific word tail from an arbitrary word or sentence,
the storage unit further stores at least one word tail portion including a plurality of labeled nodes in order to express at least one common word tail common to at least two of said plurality of vocabularies, and
the grammar network generating unit generates, when a processing for adding the target vocabulary is instructed by the first instruction, a grammar network containing the word head portion, the word tail portion, the target vocabulary selected by the second instruction, word head portion side connection information indicating that each of said plurality of the word body data contained in the target vocabulary is connected to a preliminarily matched one of said plurality of labeled nodes contained in the word head portion and word tail portion side connection information indicating that each of said plurality of the word body data contained in the target vocabulary is connected to a preliminarily matched one of said plurality of labeled nodes contained in the word tail portion.

9. The speech recognition apparatus according to claim 7, wherein when a processing for deleting the target vocabulary is instructed, the grammar network generating unit deletes the target vocabulary and the word head portion side connection information and the word tail portion side connection information corresponding to the target vocabulary from the grammar network.

10. The speech recognition apparatus according to claim 9, wherein each of the word body data is constituted of a network containing a labeled node sequence, and
the speech recognition apparatus further comprises an updating unit configured to update the word head portion and the word tail portion so as to reduce the number of the labeled nodes contained in two or more of the word body data and updates said two or more of the word body data so as to be fitted to the updated word head portion and the word tail portion.

11. The speech recognition apparatus according to claim 10, wherein the word head portion is constituted of a network containing the labeled nodes with an initial condition node serving as a route node,
the word tail portion is constituted of a network containing the labeled nodes with a final condition node serving as a leaf node, and
with the initial conditions of the word head portion and the word tail portion containing only the initial condition nodes and the final condition nodes respectively, the updating of the word head portion and the word tail portion and the updating of the word body data are carried out.

12. The speech recognition apparatus according to claim 9, wherein the storage unit further stores a grammar frame which is a model of the grammar network, defining at least one of the portions in which the vocabulary is variable in the grammar network, and
the grammar network generating unit generates the grammar network with the grammar frame used as a model.

13. The speech recognition apparatus according to claim 12, wherein each of the word body data is constituted of a network containing a labeled node sequence, and
the speech recognition apparatus further comprises an updating unit configured to update the word head portion and the word tail portion so as to reduce the number of the labeled nodes contained in two or more of the word body data and updates said two or more of the word body data so as to be fitted to the updated word head portion and the word tail portion.

14. The speech recognition apparatus according to claim 13, wherein the word head portion is constituted of a network containing the labeled nodes with an initial condition node serving as a route node,
the word tail portion is constituted of a network containing the labeled nodes with a final condition node serving as a leaf node, and
with the initial conditions of the word head portion and the word tail portion containing only the initial condition nodes and the final condition nodes respectively, the updating of the word head portion and the word tail portion and the updating of the word body data are carried out.

15. The speech recognition apparatus according to claim 1, wherein when the processing for adding the target vocabulary is instructed by the first instruction, in the case where a grammar network to be generated initially, the grammar network generating unit generates the grammar network containing only the word head portion, and then adds the target vocabulary and the word head portion side connection information corresponding to the target vocabulary to the generated grammar network, and in the case where the grammar network already exists, the grammar network generating unit adds the target vocabulary and the word head portion side connection information corresponding to the target vocabulary to the existing grammar network

16. The speech recognition apparatus according to claim 8, wherein when the processing for adding the target vocabulary is instructed by the first instruction, in the case where a grammar network to be generated initially, the grammar network generating unit generates the grammar network containing only the word head portion and the word tail portion, and then adds the target vocabulary and the word head portion side connection information and the word tail portion side connection information corresponding to the target vocabulary to the generated grammar network, and in the case where the grammar network already exists, the grammar network generating unit adds the target vocabulary and the word head portion side connection information and the word tail portion side connection information corresponding to the target vocabulary to the existing grammar network

17. A grammar network generation method comprising:
storing a plurality of vocabularies, each of the vocabularies including a plurality of word body data, each of the word body data being obtained by removing a specific word head from an arbitrary word or sentence, and storing at least one word head portion including a plurality of labeled nodes in order to express at least one common word head common to at least two of said plurality of vocabularies;
receiving a first instruction for selecting a target vocabulary from said plurality of vocabularies and a second instruction for instructing the content of a operation to the target vocabulary;
generating, when a processing for adding the target vocabulary is instructed by the first instruction, a grammar network containing the word head portion, the target vocabulary selected by the second instruction and word head portion side connection information indicating that each of said plurality of the word body data contained in the target vocabulary is connected to a preliminarily matched one of said plurality of labeled nodes contained in the word head portion; and
executing speech recognition using the generated grammar network which provides a set of recognition target words or sentences.

18. A computer readable storage medium storing instructions of a computer program which when executed by a computer results in performance of steps comprising:
storing a plurality of vocabularies, each of the vocabularies including a plurality of word body data, each of the word body data being obtained by removing a specific word head from an arbitrary word or sentence, and storing at least one word head portion including a plurality of labeled nodes in order to express at least one common word head common to at least two of said plurality of vocabularies;
receiving a first instruction for selecting a target vocabulary from said plurality of vocabularies and a second instruction for instructing the content of a operation to the target vocabulary;
generating, when a processing for adding the target vocabulary is instructed by the first instruction, a grammar network containing the word head portion, the target vocabulary selected by the second instruction and word head portion side connection information indicating that each of said plurality of the word body data contained in the target vocabulary is connected to a preliminarily matched one of said plurality of labeled nodes contained in the word head portion; and
executing speech recognition using the generated grammar network which provides a set of recognition target words or sentences.
